(19) United States
(12) Patent Application Publication
(10) Pub. No.: US 2020/0256650 A1
(43) Pub. Date: Aug. 13, 2020

(54) Sera Intelligent

(71) Applicant: Crystal Sylver, San Francisco, CA (US)

(72) Inventor: Crystal Sylver, San Francisco, CA (US)

(21) Appl. No.: 16/221,447

(22) Filed: Feb. 11, 2019

(51) Int. Cl. F41H 13/00; F41G 1/35; G01V 3/08

(52) U.S. Cl. CPC F41H 13/0062; H04N 5/23216; G01V 3/08; F41G 1/35

(57) ABSTRACT

The invention is a smart laser defense weapon, specialized to avoid killing humans.

### CROSS-REFERENCE TO RELATED APPLICATIONS

Sera Intelligent

Provisional Patent Filed Dec. 15, 2017

Application No. 62/708,604

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The Sera Intelligent is an electrical device. It is a sensory driven smart laser gun, designed as a defense weapon rather than a lethal and dangerous weapon.

Traditional guns and laser guns are designed to kill and cause bodily harm with traditional targets being the heart and head.

Tasers are unreliable as defense weapons and can also kill if used directly on the heart.

Accidental deaths by shooting, malicious intent to kill or harm another, and suicides are also concerns with traditional guns or defense weapons for the general public. Public safety is at risk when guns are not monitored, tracked, or registered to one user.

### BRIEF SUMMARY OF INVENTION

The Sera Intelligent is a sensory driven, computer chip, and battery powered smart laser gun designed to avoid human internal organs, as well as the head and face, in order to disarm assailants without causing lethal harm. It is a defense weapon meant to defend oneself, not to kill another, and create responsible weapon ownership. It is fingerprint activated with a coded lock, and has a GPS tracker, camera, and metal detector built-in as safety features. It also comes with a laser pointer, high-powered flashlight, and interchangeable collimator and night vision attachments.

It is a reliable defense weapon meant to protect people's lives and create responsible gun ownership.

### BRIEF DESCRIPTION OF THE SEVERAL VIEWS OF THE DRAWING

1/4 FIG. 1—Front view of Sera Intelligent,

FIG. 2—Side view of Sera Intelligent,

FIG. 3—Close up sectional of front view

2/4 Cross-section side internal view with collimator sight

3/4 Three-quarter view with collimator sight

4/4 FIG. 1—Front view with night vision sight,

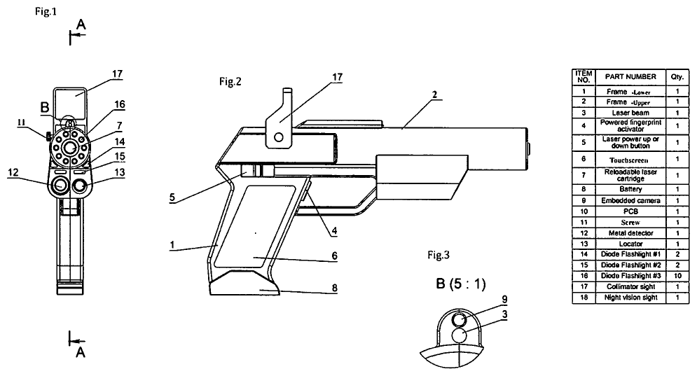

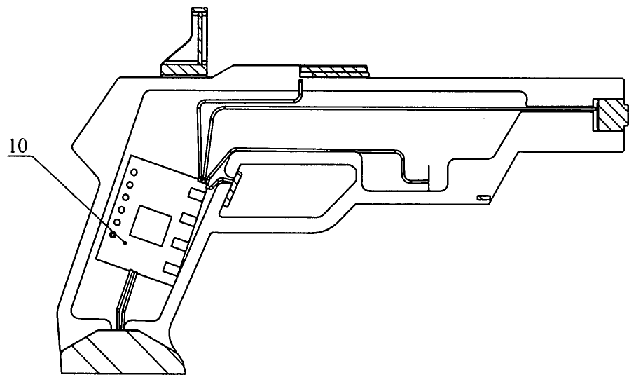

FIG. 2—Side view with night vision sight,

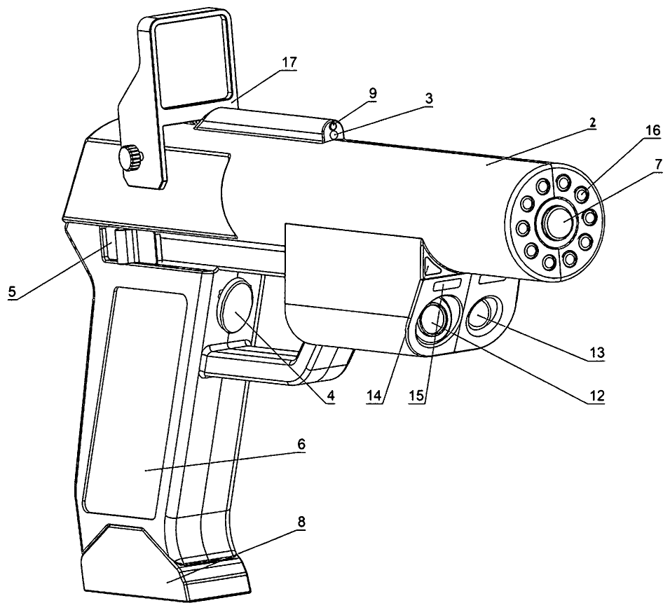

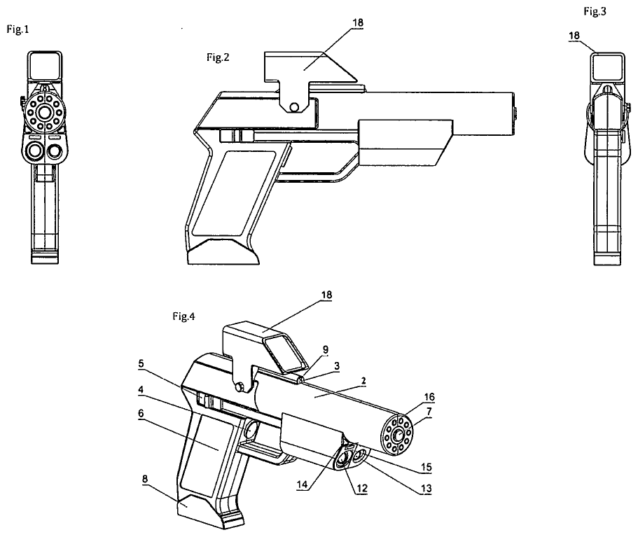

FIG. 3—Back view with night vision sight,

FIG. 4—Three-quarter view with night vision sight

1. Frame-Lower
2. Frame-Upper
3. Laser Beam
4. Powered Fingerprint Activator
5. Laser Power Up or Down Button
6. Touchscreen
7. Reloadable Laser Cartridge
8. Battery
9. Embedded Camera
10. PCB
11. Screw
12. Metal Detector
13. Locator
14. Diode Flashlight #1
15. Diode Flashlight #2
16. Diode Flashlight #3
17. Collimator Sight
18. Night Vision Sight

The Frame-Lower (1) holds the lower portion of the invention together. The Frame-Upper (2) holds the upper portion of the invention together. The Laser Beam (3) is the pointer located on the top upper frame. The Powered Fingerprint Activator (4) is the trigger located on the lower frame. The Laser Power Up or Down Activator (5) is located on the lower frame. The Touchscreen (6) is located on the lower frame. The Reloadable Laser Cartridge (7) is located inside the upper frame. The Battery (8) is at the base of the lower frame. The Embedded Camera (9) is located on the upper frame. The PCB (10) is located inside behind the touchscreen. The Screw (11) holds the collimator or night vision pieces in place. The Metal Detector (12) is located below the laser cartridge. The Locator (13) is located next to the metal detector. The Diode Flashlight #1 (14) is located beneath the laser cartridge (two). The Diode Flashlight #2 (15) is located beneath diode flashlight #1 (two). The Diode Flashlight #3 (16) is located around the circumference of the laser cartridge (ten). The Collimator Sight (17) is an interchangeable piece located on top of the upper frame. The Night Vision Sight (18) is an interchangeable piece located on top of the upper frame.

### DETAILED DESCRIPTION OF THE INVENTION

The lower frame, also the grip handle, houses the PCB inside the frame, which controls the device and all the components as well as the touchscreen display. The touchscreen display controls all the different components of the device. The battery is located at the base of the device and can be charged or replaced as needed. The fingerprint activator is the trigger that fires the laser and is a part of the grip handle. The laser strength is controlled by the laser power up or down button. The reloadable laser cartridge is the laser that is fired and can be changed if necessary. The laser beam is located beneath the embedded camera and provides point of contact. The embedded camera, located on top of the upper frame records live data. The metal detector, located beneath the laser cartridge and flashlight diodes, relays information to touchscreen on metal detection. The locator, located next to the metal detector beneath the laser cartridge and flashlight diodes, provides sensory driven input on targets. The diode flashlight #3 surrounds the laser cartridge with up to 600+ lumens. The diode flashlights #1 and #2 are located above the metal detector and locator, and provide night vision infrared illuminator light. The screw holds the interchangeable collimator or night vision pieces in place, or can be removed. The collimator sight piece can be attached for an illuminated aiming point view, and the night vision sight piece can be added for an illuminated aiming point view at night.

The invention is a battery powered computer chip operated laser gun with a touchscreen display that powers on and off the device when needed and relays all information about the device while gathering information when on. The display shows when the power is on, battery levels, laser strength, location of device with GPS, camera feed that can be live streamed to a computer, the coded lock and fingerprint activator, metal detection device, as well as a locator for sensory readings on targets. The gun will not fire if aimed at internal organs, head or face. When target is met, the gun can be activated and fired.

The device is registered to one person or family through fingerprints. The device is powered on to use and remains off when not in use. Coded lock on touchscreen increases safety. Fingerprint activator reads fingerprints and will only fire laser if registered fingerprints match in order to avoid theft of device, misuse of device, or playing with device. The fingerprint is also recorded when fired to ensure complete transparency on the device's use. The device has a powerful lumen flashlight in order to see at night and infrared illuminated light for night vision. It has a laser beam pointer for target detection and sensory locator that is designed to locate human internal organs, heads and faces, and will not fire laser until safe target is met, which consists of arms, hands, legs or feet. The trigger can be held down until target is met and then the laser will fire. The metal detector relays information back to the touchscreen if any metal is detected on target to increase safety of all persons involved. The laser cartridge can be replaced and the strength level controlled by the power up and down button in order to create a stream of laser energy. A lower strength stream of laser energy for stunning or a higher strength laser energy for disarming or harming for defense and protection. The embedded camera records target the moment the device is turned on. The recording can be live-streamed to a computer monitor. A GPS tracker located in the PCB computer chip monitors the whereabouts of the device if lost, stolen, turned on, or fired. The device records the time, location, and target when turned on and fired. The moment the device is turned on it can be signaled back to another registered user, family member, or law enforcement agency, with information on user and location. This creates responsible gun ownership and transparency on use, minimizing criminal activity, malicious intent, family shooting, suicides, and accidental deaths. The interchangeable collimator and night vision pieces allow for a clear illuminated image of target whether during day or night. Or these pieces can be removed all together.

The device is designed not to kill another person or oneself. It is a safe defense weapon which is registered to one user or family, and remains off and locked until needed, which should only be in an emergency for defense of one's life, and not to cause harm or death to another, but to stop them, shock them, stun them, or disarm them, while at the same time relaying live information back to family or law enforcement. The moment the device is turned on a message could potentially be sent to a family member or law enforcement, signaling danger and that the user needs help, which a family member or police officer could respond to immediately.

This is a defense weapon that must be registered to a user and a safety lesson should be given for appropriate use. Otherwise detailed instructions on how to best use it can be given with device. It can shoot at a target that does not have human internal organs, head or face, for practice and for skill development of device. The device remains off and is turned on by the touchscreen. A power on/off button can also be added separate from the touchscreen. A code may be entered to unlock device on touchscreen. A coded lock may be added separate from touchscreen. The touchscreen display shows camera recording, night or day use, proper component use for night or day, and laser strength activated. For best use, the device should be pointed at target in order to detect metal, which will also appear on display with a sound relaying the message that metal is detected. To fire the device the fingerprint activated trigger must match a registered user and then the trigger will activate the laser when pressed and held down. The sensory locator will immediately detect human internal organs, head, and face and will not allow the laser to be fired, even if fingerprint activated trigger is held down. If the laser is being fired, as soon as the locator sensor detects internal organs, head, or face the laser will stop, and will fire again as long as the trigger is held down and the locator sensor has moved away from organs, head, or face. The device can be charged after use and remain off until used again.

This invention can be used as a defense weapon for law enforcement, security, correctional officers, highway patrol, police, university and school campus police, BART police, bodyguards, in private homes, and for the general public. It can be connected to a computer monitoring system to monitor the whereabouts and use of all laser defense weapons at all time to create weapon responsibility and transparency, making it safer for police and civilians. This allows police and civilians to know who has a weapon, it's location, and if it's on. This would greatly minimize criminal activity, mass shootings, school shootings, gang related violence, accidental deaths, police shootings, and the ability for individuals to secretly use, hide, or steal a weapon without law enforcement or the community knowing.

This invention can be used as a stun gun without the organ sensory locator. It can be used as a regular gun without the organ sensory locator turned on or removed entirely with the ability to shoot anywhere on the body. It can be created without the camera. It can be created without the metal detector. It can be created without the sensory locator. It can be created without the interchangeable collimator and night vision pieces. It can be created without a touchscreen. It can be created without a lumens flashlight or any strength level of light. It can be created with less diode or more diodes for light. It can be created without an infrared illuminated light. It can be created with one laser strength level up to several different laser strengths. It can be sensory driven to hit a target of human internal organs, or specific organs, head, or face. This invention could be used for hunting or stunning animals. It could be used for protection around dangerous animals to avoid killing them.

This invention improves upon the current weapons models, such as the Taser gun and traditional guns, as far as a real defense weapon is concerned. This invention is a reliable, smart, highly efficient, safe, community friendly, civilian friendly, police friendly, transparent defense weapon, which is also safe and reliable for people not interested in guns but would like a safe defense weapon in their home.

1. The invention claimed is a smart laser gun comprised of:
a battery;
a PCB powered touchscreen display for interactive use, recording, and monitoring of device;
a fingerprint-activated trigger;
a coded lock;
a laser cartridge for firing laser energy;
a laser beam pointer located on the top frame;
a laser strength button located on the side of the frame to create different laser strengths for stunning or harming;
a metal detector located beneath the laser cartridge to detect metal on target;
a sensory locator beneath the laser cartridge for sensory driven targeting, mainly to avoid human internal organs, heads, and faces;
an embedded camera located on the top frame for recording use;
lumens 600+ diode flashlight surrounding the laser cartridge;
infrared illuminated night vision diode flashlight located below lumens flashlight;
a detachable collimator sight piece for focused images;
a detachable night vision piece for focused images in dark light;
Dependent claims

2. The smart laser gun as recited in claim 1, may be used as a stun gun without the organ sensory locator.

3. The smart laser gun as recited in claim 1, may be used as a regular laser gun without the organ sensory locator turned on or removed entirely with the capability to shoot anywhere on the body.

4. The smart laser gun as recited in claim 1, may be designed with the organ sensory locator built into another location.

5. The smart laser gun as recited in claim 1, may be designed without the metal detector or the metal detector built into another location.

6. The smart laser gun as recited in claim 1, may be designed without a touchscreen and replaced with manual buttons.

7. The smart laser gun as recited in claim 1, may be designed without the collimator and night vision pieces.

8. The smart laser gun as recited in claim 1, may be designed without a lumens flashlight or any different type or strength of light.

9. The smart laser gun as recited in claim 1, may be designed with any number of flashlight diodes, less than 10 or greater than 10 for the lumens light.

10. The smart laser gun as recited in claim 1, may be designed without infrared illuminated light or replaced with another light.

11. The smart laser gun as recited in claim 1, may not be designed with an embedded flashlight, but have an additional attachment for the flashlight.

12. The smart laser gun as recited in claim 1, may be designed to have one laser strength, two laser strengths, or multiple laser strengths.

13. The smart laser gun as recited in claim 1, may be sensory driven to hit human internal organs or specific organs, as well as the head and face.

14. The smart laser gun as recited in claim 1, may be designed for hunting or stunning animals, or for protection from dangerous animals to avoid killing them.

15. The smart laser gun as recited in claim 1, may have a coded lock built into the device separate from the touchscreen or it may not have one at all.
